(19) United States
(12) Patent Application Publication
(10) Pub. No.: US 2008/0146681 A1
(43) Pub. Date: Jun. 19, 2008

(54) Method Of Producing Modified Metal Oxides That Are Dispersible In An Organic Matrix

(76) Inventors: Thomas J. Martin, Bixby, OK (US); April J. Arthur, Portland, OR (US); C.Todd Hancock, Lake Charles, LA (US); Victoria L. Stolarski, Lake Charles, LA (US)

Correspondence Address: C. JAMES BUSHMAN, 5718 WESTHEIMER, SUITE 1800, HOUSTON, TX, 77057, US

(21) Appl. No.: 11/587,502

(22) PCT Filed: Apr. 21, 2005
(86) PCT No.: PCT/US05/13682

§ 371 Date: Aug. 30, 2007

Related U.S. Application Data
(63) Continuation-in-part of application No. 10/831,827, filed on Apr. 26, 2004, now abandoned.

(51) Int. Cl. B01F 3/12; B01F 17/00

(52) U.S. Cl. 516/85

(57) ABSTRACT

A method of preparing a metal oxide which is dispersible in organic matrices such as apolar organic liquid wherein a product mixture is formed by adding sol of the metal oxide to an aqueous suspension of a sulfonic acid modifier, the modified metal oxide being recovered from the product mixture.

### CROSS REFERENCE TO RELATED APPLICATIONS

This application is a continuation-in-part application of U.S. patent application Ser. No. 10/831,827 filed Apr. 26, 2004, for METHOD OF PRODUCING MODIFIED METAL OXIDES THAT ARE DISPERSIBLE IN AN ORGANIC MATRIX, the disclosure of which is incorporated herein by reference.

### BACKGROUND OF THE INVENTION

1. Field of the Invention

The present invention relates to the preparation of modified metal oxides which are dispersible in organic matrices.

2. Description of the Prior Art

Recently there has been an emphasis on the production of modified metal oxides such as aluminas to render the metal oxides dispersible in various organic matrices, e.g., polymers, organic liquids and the like. The prior art discloses methods to prepare metal oxides which are dispersible in aqueous mediums and polar organic liquids. See in this regard, U.S. Pat. Nos. 4,676,928 and 6,224,846. While these dispersible metal oxides, e.g., aluminas, have a wide variety of uses, it clearly would be desirable to have metal oxides which are dispersible in organic matrices, as for example in apolar organic solvents. In particular, it would be desirable to have metal oxides that are dispersible in apolar organic solvents or liquids and that form stable sols.

U.S. Pat. No. 6,224,846 discloses modified aluminas which are dispersible in polar organic and/or aqueous media. PCT/DE00/02163 discloses a method for preparing metal oxides which are dispersible in organic solvents, the metal oxides being modified with organic sulfonic acids.

### SUMMARY OF THE INVENTION

In accordance with one preferred embodiment of the present invention, there is provided a method of preparing a metal oxide that is dispersible in an organic matrix. In this preferred embodiment there is formed a reaction product mixture by adding an aqueous sol of a metal oxide to an aqueous suspension of a sulfonic acid modifier having the structure

X(SO_{y})ₙM I

wherein X is an organic moiety, M is a monovalent cation, y is 3 or 4, and n is an integer reflecting the number of —SO_{y}M groups bonded to the organic moiety, to produce a modified metal oxide. The modified metal oxide is recovered from the reaction product mixture and, preferably after drying, can be dispersed in various organic matrices, e.g., apolar organic liquids, to form stable organic sols of the metal oxides, or in organic matrices such as molten polymers to form nanocomposites wherein the modified metal oxide is uniformly dispersed throughout the matrix.

In accordance with another preferred embodiment of the present invention a reaction product mixture is formed by adding an aqueous sol of a metal oxide to an aqueous suspension of a sulfonic acid modifier having the formula:

X(SO_{y})ₙM I

wherein X is an organic moiety, M is a monovalent cation, y is 3 or 4, and n is an integer reflecting the number of —SO_{y}M groups bonded to the organic moiety, to form a modified metal oxide, the weight ratio of metal oxide, calculated as metal oxide, to sulfonic acid modifier, calculated as X(SO_{y})ₙM being from 98:2 to 50:50. The modified metal oxide is removed from the reaction product mixture, and dried at a temperature of from 60° to 115° C.

In yet another preferred embodiment of the present invention there is provided a method of preparing a metal oxide which is dispersible in aprotic polar organic liquids. In this preferred embodiment, an aqueous slurry solution of an acid dispersible metal oxide is reacted with an aqueous solution of a mono-protic acid having a pKa value of less than 6 to produce an aqueous sol of the metal oxide. The aqueous sol of the metal oxide is mixed with an aqueous suspension of a sulfonic acid modifier selected from the group consisting of compounds having the formula:

RSO_{y}M II

wherein R is an organic group having from 1 to 12 carbon atoms, M is a monovalent cation, and y is 3 or 4; compounds having the formula:

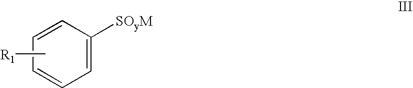

wherein R₁ is an organic moiety containing from 1 to 6 carbon atoms, and wherein R₁ can be substituted with functional groups, and mixtures thereof, to form a reaction product mixture. Modified metal oxide is removed from the reaction product mixture.

### DESCRIPTION OF THE PREFERRED EMBODIMENTS

The term “metal oxide”, as used herein, includes not only metal oxides per se but various hydrates thereof. The metal oxides which are useful in the present invention are those metal oxides which can be treated to form aqueous sols, i.e., stable aqueous dispersions, essentially colloidal in nature, of the metal oxide. Such oxides, when in the sol form, have a particle size of less than about one micron. Generally speaking, the particle size of the metal oxide in the aqueous sols will be from 1 to 500 nm, preferably from 5 to 50 nm. Generally, the metal oxides which are useful in the present invention include aluminas, e.g., boehmites, pseudoboehmites, various other forms of alumina, silica, mixed oxides of silicon and aluminum, aluminum silicate, etc. The preferred metal oxides are aluminas e.g. boehmite, pseudoboehmite, etc.

According to one aspect of the present invention, an aqueous sol of the metal oxide is added to an aqueous dispersion of a sulfonic acid modifier described more fully hereafter. The term “aqueous sol” is intended to mean a dispersion of the metal oxide wherein the metal oxide remains suspended in the aqueous medium without any significant settling under quiescent conditions. The amount of metal oxide in the aqueous sol can vary over wide limits but generally will be in the range of from about 1 to 15 wt. %, calculated as metal oxide.

The metal oxide sols useful in the method of the present invention can be prepared by reacting metal oxide, e.g., boehmite, pseudo-boehmite, etc., with a mono-protic acid to effect peptization of the metal oxide and thereby form the aqueous sol. The mono-protic acids useful in the peptization step of the present invention are generally organic acids, having a pKa of less than 6. Non-limiting examples of such acids include carboxylic acids having from 1 to 4 carbon atoms. In addition mono-protic mineral acids such as nitric acid can be employed. Preferably, the mono-protic acid is volatile at the temperature at which the subsequent, modified product is dried so that any free mono-protic is either volatilized or decomposed and removed from the final product. Preferred mono-protic acids include formic acid, acetic acid, nitric acid, etc.

In general, the amount of mono-protic acid employed will vary with the nature of the metal oxide. However, the amount of mono-protic acid used in the peptizing step will be up to 8% by weight metal oxide, especially alumina.

The peptization of the metal oxide to produce the sol and the reaction of the peptized metal oxide with the sulfonic acid modifier can be performed in a two-step or one-step method. In the two-step method, an aqueous slurry of the metal oxide is mixed with an aqueous solution of the desired amount of the peptizing mono-protic acid and the resulting mixture, which has been thoroughly mixed to obtain a homogenous suspension, is optionally charged to a suitable reactor where it is heated at a temperature of from 0° to 200° C. for a period of time ranging from 0 to 300 minutes. Following cooling, the solution is spray dried or dried in some other convenient fashion to recover the peptized, dry metal oxide powder. Subsequently, the dried, peptized metal oxide powder is dispersed in water and admixed with the sulfonic acid modifier. Optionally, this mixture can be heated to a temperature of from 0° to 200° C. for a period of time ranging from 0 to 300 minutes, depending upon the nature of the metal oxide and/or the sulfonic acid modifier. The modified metal oxide is thus removed and dried.

In the one-step method, a dispersion of the metal oxide powder in water is prepared and admixed with an aqueous solution of the mono-protic acid. The resulting mixture is charged to a suitable reactor where it is heated at a temperature of from 0° to 200° C. for a period of from 0 to 300 minutes. The aqueous mixture is cooled and then mixed with an aqueous solution/dispersion of the sulfonic acid modifier and allowed to mix for a period of time ranging from 5 minutes to 1 hour. Optionally, the sulfonic acid modified alumina may be hydrothermally or solvothermally aged at temperatures of from 0° to 200° C. for a period of from 0 to 300 minutes to effect crystal growth. This produces the modified metal oxide which can then be recovered by spray drying or some other suitable technique well known to those skilled in the art.

Sulfonic acid compounds (modifiers) useful in the method of the present invention are those having the formula:

X(SO_{y})ₙM I

wherein X is an organic moiety, M is a monovalent cation, y is 3 or 4, and n is an integer reflecting the number of —SO_{y}M groups bonded to the organic moiety. It will be recognized from the above formula that the type of sulfonic acid compounds employed in the process of the present invention can vary widely.

Non-limiting examples of suitable sulfonic acid modifiers covered by the above general formula include alkyl sulfonic acids having the formula:

RSO_{y}M II

wherein R is an alkyl group having from 1 to 16 carbon atoms; aryl sulfonic acids having the formula:

ArSO_{y}M IV

wherein Ar is an aryl group wherein the aryl group can be a phenyl group, a benzyl group, a tolyl group, a naphthyl group, or any other molecule containing an aromatic nucleus, including condensed six carbon rings, compounds such as phenanthrene, anthracene, etc.; metallo-organic compounds with sulfonic acid functionalities; polymers such as sulfonated styrene-butadiene copolymers, sulfonated fluorocarbons, etc.; sulfonated chiral species; and virtually any other sulfonated organic species that can be used to modify the boehmite alumina. Particularly preferred when making a dispersible modified alumina are sulfonic acid modifiers such as alkyl sulfonic acids, including methane sulfonic acid, ethane sulfonic acid, and other alkyl or alkylaryl sulfonic acids, such as alkyl benzenesulfonic acids, aliphatic sulfonic acids, aryl sulfonic acids such as p-toluenesulfonic acid, phenol red. It will be appreciated that the alkyl sulfonic and aryl sulfonic acids and alkylaryl sulfonic acids include substituted alkyl and aryl sulfonic acids such as, for example, trifluoromethane sulfonic acid, phenol red, sulfonated xylenes, and other, more complex molecules, that contain sulfonic acid functionality but that are free of substituents or groups that would deleteriously affect the modification of the boehmite alumina to a modified boebmite alumina.

An especially preferred group of sulfonic acids modifiers are represented by the formula:

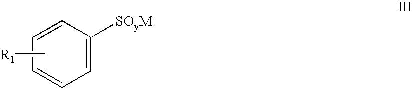

wherein R₁ is an organic moiety containing from 7 to 20 carbon atoms, preferably from 16 to 20 carbon atoms and R₁ can be substituted with other functional groups such as OH, —NH₂, etc. and can be unsaturated. Especially preferred are compounds wherein R₁ is an alkyl group containing from 7 to 20 carbon atoms, preferably from 10 to 14 carbon atoms. The R group of formula II can have the same structure as the R₁ group, as described above.

In cases where it is desired to have a modified metal oxide which is dispersible in aprotic polar organic compounds, e.g., ketones, it has been found desirable to utilize, as the sulfonic acid modifier, one of the sulfonic acids depicted by formulae II or m above wherein as the compounds covered by formula II, R is an organic group containing from 1 to 12 carbon atoms and as to formula III, R₁ has from 1 to 6 carbon atoms. These sulfonic acids which can be considered non-bulky, are particularly useful at modifying the surface of the metal oxide so as to make it dispersible in aprotic, polar organic solvents while it remains essentially non-dispersible in water. Thus, an especially preferred embodiment of the present invention involves peptization, as described above, of the metal oxide to form a sol followed by surface treatment with one of the sulfonic acids of formula II or formula III. In particular, as will be seen below, when one of these non-bulky sulfonic and modifier, particularly p-toluene sulfonic acid (pTSA) is used, the resulting modified metal oxide (modified boehmite) shows excellent dispersibility in aprotic, polar organic liquids such as ketones, e.g., acetone, methyl ethyl ketone (MEK), etc. In this regard, and as used herein, a dispersibility of the modified metal oxide of greater than 85% wt. is preferred for material to be considered dispersible in a given solvent.

As noted above, M is a monovalent cation, preferably hydrogen. However, M can also be sodium, potassium, lithium, etc, provided that such ions are not present in amounts that cause gelling.

As can be seen from the above with respect to the type of sulfonic acid modifiers that can be employed, the value of n and, more specifically, the sulfonic acid content of the sulfonic acid modifier can vary widely. For example, in the case of an alkyl sulfonic acids, such as methane sulfonic acid, the sulfonic acid content of the molecule on a weight basis is quite high. On the other hand, in the case of a sulfonated polymer, such as a sulfonated styrene butadiene polymer, the weight content of the sulfonic acid in the polymer might be relatively small, depending on the degree of sulfonation. Indeed, it is this wide disparity in the amount of the sulfonic acid present in the sulfonic acid modifier that allows for tailoring of the metal oxides to achieve a modified metal oxide with desired properties. In general, the sulfonic acid modifier can contain from as little as 5% by weight sulfonic acid to as much as 85% by weight sulfonic acid, calculated as —SO_{y}H.

The sulfonic acid modifier useful in the present invention must be of a type that forms a stable suspension or dispersion in an aqueous medium. The terms “suspension” or “dispersion,” with respect to the sulfonic acid modifier, includes solutions, emulsions, colloidal dispersions, etc. In general, the dispersions will have the characteristic that there is no substantial settling of the sulfonic acid modifier from the aqueous medium under quiescent conditions.

The amount of sulfonic acid modifier in the aqueous dispersion can vary over wide limits but generally will be in the range of from about 0.02 to about 10 wt. %, calculated as —SO_{y}H.

According to one preferred mode of the present invention, the aqueous sol of the metal oxide is added to the aqueous suspension of the sulfonic acid modifier to provide a uniform mixture of the components. Generally speaking, the weight ratio of metal oxide, calculated as metal oxide, to sulfonic acid modifier, calculated as X(SO_{y})ₙM in the mixture is from 98:2 to 70:30. The mixing can be carried out at room temperature and, depending upon the particular metal oxide sol and/or sulfonic acid modifier, will produce a modified metal oxide which is dispersible in an organic matrix. Optionally, the mixture can be heated to a temperature of from 0 to 200° C. for 0 to 300 min., again depending upon the nature of the metal oxide and/or the sulfonic acid modifier.

After the modified metal oxide has been formed, which especially in the case of bulky sulfonic acid modifiers may be indicated by formation of solids, e.g., a floc, the solids are separated from the reaction product mixture by centrifuging, decanting, filtering or any other technique which results in dewatering of the solid, modified metal oxide. The wet, modified metal oxide is then dried by any conventional means, e.g., oven drying, spray drying, etc. Indeed, drying is preferred as it leads to modified metal oxides which display enhanced dispersibility in organic matrices. Generally, the drying will be carried out at a temperature of from 60 to 120° C. for a period of time sufficient to remove substantially all free water.

The modified metal oxide produced by the process of the present invention can be uniformly dispersed in organic matrices to produce a wide variety of products such as nanocomposites, transparent or translucent dispersions of the modified metal oxides in apolar organic liquids, etc. The term “organic matrix,” as used herein, is intended to include any organic composition which is either fluid (liquid) or can be converted into a fluid state such that the modified metal oxide can be uniformly dispersed therein. Non-limiting examples of such organic matrices include organic solvents, particularly apolar organic solvents, aprotic polar organic solvents, flowable, high viscosity resins or polymers, molten polymers, etc. One particularly preferred group of organic matrices comprise organic solvents or liquids and more particularly, aromatic organic liquids such as benzene, toluene, xylene, cumene, etc. A characteristic of the modified metal oxides of the present invention is that, because of their dispersibility, i.e., their non-agglomeration tendency, organic matrices containing uniform and high loadings of the modified metal oxides can be achieved. Indeed, organic matrices containing up to 40% by wt. of modified metal oxide can be produced. When the organic matrix is an apolar organic liquid, the modified metal oxide will generally be present in an amount of from 1 to 20% by wt. A second particularly preferred group of organic matrices comprises polar, aprotic solvents such as ketones, aldehydes, etc., including acetone, methyl ethyl ketone and aldehydes, etc.

It has been found that particularly optimal results of dispersibility, particularly in the case of more bulky sulfonic acid modifiers such as linear alkyl benzene sulfonates (LAS) can be achieved when optimal amounts of the sulfonic modifier are used in relationship to the metal oxide and if particular drying conditions are employed. Thus, it has been found that if the weight ratio of metal oxide, calculated as a metal oxide, to sulfonic acid modifier, calculated as X(SO_{y})ₙM, in the mixture is from 98:2 to 50:50, much higher dispersibility in non-polar or apolar organic matrices, e.g., toluene, is achieved, particularly when the drying of the modified metal oxide is conducted in a temperature range of from 60 to 115° C. for a period of time sufficient to remove substantially all free water. In short residence time drying systems, such as spray dryers, the preferred temperature range is 100 to 120° C.

It will be recognized that in employing the method of the present invention, which results in modifying a metal oxide to enhance its dispersibility in organic matrices, both polar and non-polar, different metal oxides, e.g., alumina, starting materials with varying surface areas require differing amounts of the sulfonic acid modifier in order to achieve the same degree of surface functionalization and hence organic matrix (particularly apolar organic liquid) dispersibility. For example, the literature reports that boehmite alumina has 4.71×1018 reaction sites per square meter of surface area. Accordingly, full surface coverage, alternatively described as 100 mol % modifier loading or 100% mol coverage, would correspond to 4.71×1018 molecules of sulfonic acid modifier per unit of surface area, or 7.82×10−6 mols of sulfonic acid modifier per square meter of alumina surface area. In a typical boehmite alumina, 50% mol coverage will occupy sufficient sites to give adequate surface functionalization. However, it has been found that increasing the sulfonic acid modifier loadings above 50% mol coverage results in improved product properties. Thus, by combining these increased loadings of the sulfonic acid modifier with particular drying conditions as noted above, one achieves a product of enhanced dispersibility particularly in apolar organic liquids such as alkanes, aromatics, etc. Thus, the amount of loading of the modifier relative to the available surface sites of the metal oxide can be adjusted to optimize the dispersibility of the product in the target matrix. To more fully illustrate the present invention, the following nonlimiting examples are presented. In examples which follow, dispersibility is indicated either by showing dispersed particle size of the resulting modified metal oxide or the percent dispersibility in the organic liquid. Either is an indication of the performance of the products obtained by the method of the present invention. Smaller dispersed particle size is indicative of more complete deagglomeration and therefore indicate preferred compatibility with the target dispersion matrix. Higher percent dispersibility is also indicative of preferred compatibility with the target dispersion matrix.

### EXAMPLE 1

Alumina sols were made up using various aluminas (pseudoboehmites). The sols were then added to aqueous solutions of the sulfonic acid modifier. The modified aluminas that were produced were recovered and spray dried at an inlet temperature of 220° C. and an outlet temperature of 100° C. with an air flow rate and sol feed rate adjusted to maintain the outlet temperature. The dried, modified aluminas were made up at 1-5% w/w levels in toluene followed by dilution with excess toluene for particle size measurement by light scattering. The results are shown in Table 1 below:

TABLE 1
Initial particle size before treatment of aqueous alumina sol,
and after treatment with sulfonic acid, redispersed in toluene

| | | | | wt. alumina | wt. sulfonic acid |
|---|---|---|---|---|---|
| Sample No. | Alumina/sulfonic acid | In water | In toluene | (wt. water) | (wt. water) |
| 1 | DISPAL ® 23A4/LAS¹ | 123 | 181 | | |
| 2 | DISPAL ® 23N4/LAS | 107 | 136 | 120 (380) | 32.9 (500) |
| 3 | DISPAL ® 23N4/LAS | 107 | 198 | 120 (380) | 32.9 (500) |
| 4 | CATAPAL ® 200/LAS | 246 | 332 | 400 (4000) | 26.8 (400) |
| 5 | DISPAL ® 23A4/LAS | 123 | 145 | 400 (4000) | 104.7 (400) |
| 6 | CATAPAL ® 200/LAS | 223 | 276 | 6.7 (50.1) | 0.48 (12.7) |
| 7 | DISPAL ® 23N4/LAS | 107 | 165/211 | 6 (19) | 1.7 (25.2) |
| 8 | DISPAL ® 23N4/LAS | 107 | 134/239 | 6 (19) | 1.7 (25.5) |
| 9 | DISPAL ® 18N4/LAS | 147 | 675 | 205.2 (649.8) | 37.6 (150.6) |
| 10 | CATAPAL ® 200/LAS | 223 | 221 | 7 (50) | 0.7 (13) |
| | | nm | nm | g | g |

¹LAS—linear alkylbenzene sulfonic acid, with alkyl group having (C₉-C₁₄ chain length, predominantly C₁₁-C₁₂ chain length.

As can be seen from the data in Table 1, with few exceptions, the particle size of the alumina in the alumina sols (water) is not markedly different from the particle size of the modified alumina in toluene (toluene sols). Further, in all cases shown in Table 1, the modified aluminas, up to a concentration of 5% w/w in toluene were stable sols and translucent to transparent, i.e., they had NTU values of less than 1,000 nm. NTU (Normal Turbidity Unit) is an art recognized measurement of turbidity.

### EXAMPLE 2

This example shows the particle size of various alumina forms, in water (sols) and, in the modified form, in toluene (sols). In all cases, a 5 g quantity of the alumina was dispersed in 25 g of DI deionized water and the particle size in the aqueous alumina sol measured. Various amounts of the alumina sol were added to aqueous dispersions (solutions) of LAS which resulted in the formation of the modified alumina floc. The floc was recovered, spray dried using the spray drying technique described above with respect to Example 1 and the dried, modified aluminas redispersed in toluene initially at about 1 to 5% w/w concentration, and the particle size measured on a further diluted sol. While, as seen from the data in Table 2, the particle size (PS) of the alumina in the aqueous sol as compared with the particle size of the modified alumina in the toluene sol varies over wide limits, in all cases, in the concentration range of from 1 to 5% w/w in toluene the mixtures were stable in the sense that there was no settling or agglomeration of the modified aluminas and the toluene sols ranged from being transparent to translucent. More specifically, all of the toluene sols in Tables 1 and 2 had an NTU of less than 1,000 nm.

TABLE 2
Particle Size for Various Alumina/Toluene Sols

| | | Surface Area | LAS added | Particle Size | Particle Size |
|---|---|---|---|---|---|
| Alumina (oxide) | Phase | (m²/g) | (g) | in Water | in Toluene |
| DISPAL ® 23A4 | small boehmite | 200 | 1.336 | 123.4 | 374.3 |
| CATAPAL ® XBX-14 | large boehmite | 75 | 0.506 | 172.6 | 524.9 |
| CATAPAL ® 200 | large boehmite | 50 | 0.348 | 227.3 | 642.6 |
| CATAPAL ® XBX-4 | large boehmite | 37 | 0.254 | 353.7 | 539.3 |
| Ceralox APA 0.5G | gamma | 60 | 0.403 | 532.4 | 241.4 |
| CATAPAL ® XO | gamma/delta/theta | 50 | 0.334 | 309.5 | 214.8 |
| CATAPAL ® XO | gamma/delta/theta | 50 | 0.334 | 297.9 | 210.2 |
| Ceralox APA 0.2 | theta | 40 | 0.273 | 320.9 | 189.7 |

### EXAMPLE 3

This example demonstrates that metal oxides other than alumina can be formed into modified metal oxides which are dispersible in apolar organic solvents such as toluene to form stable sols. The two metal oxides used were a silica-alumina marketed as SIRAL 30D by Sasol Germany GmbH and a colloidal silica marketed as LUDOX AS-30 marketed by E.I. du Pont deNemours and Company. 10 g of SIRAL 30D was added to 90 g of DI water to form the silica alumina sol. The sol in its entirety was then added to a water solution containing 8.3 g of LAS (8.3% by wt. LAS). In the case of LUDOX AS-30, 34 g of a 30% w/w sol was diluted with 100 g of DI water. The diluted sol was added to an aqueous solution of 3.67 g of LAS (2.7% by wt. LAS). The solids which formed in both cases were recovered and dried as per the conditions in Example 1. The dried powder was then redispersed in toluene. The results are shown in Table 3 below.

TABLE 3
Average Particle Size Measured by
Light Scattering and pH Values

| Material | in water - um (pH) | in toluene - um |
|---|---|---|
| Siral 30D (silica-alumina) | 0.106 (3.6) | 0.344 |
| Ludox AS-30 (colloidal silica) | 0.048 (9.7) | 2.700 |

In both cases, once again, while there was significant difference in the particle size of the unmodified metal oxides in the aqueous sols as compared with the toluene sols of the modified metal oxides, the toluene sols were stable in the sense that there was no settling of solids under quiescent conditions.

### EXAMPLE 4

Catapal® alumina was peptized with formic acid to form aqueous sols. In all cases, the aqueous alumina sols contained 12% alumina by wt. 100 g of each of the sols was mixed with 100 g of a solution of an LAS marketed as BIO-SOFT S-101 by Stepan Company. The flocs which formed were spray dried according to the procedure of Example 1 and the spray dried organo modified aluminas were dispersed in various solvents at a 5% wt./wt. level the average particle size of each sample was determined by light scattering measurements. The results are shown in Table 4 below.

TABLE 4

| | |
|---|---|
| V1218-31 | (toluene) = 79.0 nm |
| V1218-31 | (xylene) = 88.8 nm |
| V1218-31 | (hexane) = 41.8 nm |
| V1218-31 | (pentane) = 51.7 nm |
| V1218-31 | (MEK) = 248.6 nm |
| V1218-31 | (THF) = 114.6 nm |
| V1218-31 | (chloroform) = 112.4 nm |
| V1218-31 | (IPA) = settles |
| V1218-31 | (EtAc) = settles |
| V1218-31 | (acetone) = settles |
| V1218-31 | (MeOH) = settles |
| V1218-31 | (EtOH) = settles |
| V1218-31 | (H2O) = settles |

It is apparent from the data in Table 4 that LAS treated alumina gives very small dispersed particle sizes in non-polar solvents but is not dispersible in water or highly polar organics, e.g., alcohols.

It was noted that the untreated alumina, i.e., the initial peptized product of CATAPAL® A and formic acid, has a dispersed particle size in water of approximately 40-50 nm. By comparison, the data in Table 4 shows that the present invention is capable of preventing the irreversible agglomeration of the alumina in water when treated with LAS followed by drying. The spray dried, treated alumina is capable of being redispersed in non-polar organics to roughly the same particle size as in water for the non-treated aluminas.

As can be seen from the above, in performing the method of the present invention, it is essential to use the sol of the metal oxide as that term is defined above in order to prepare the modified metal oxides of the present invention. In other words, the metal oxide sol must be of a nature such that there is minimal agglomeration of the metal oxide particles which occurs in the presence of the sulfonic acid modifier in order to provide as much available metal oxide surface as possible for treatment with the sulfonic acid modifier. If the metal oxide surface is not fully available for surface treatment with the sulfonic acid modifier, the sulfonic acid modifier is simply lost in the water phase upon drying. To highlight this feature of the invention, the following experiments were conducted.

### EXAMPLE 5

CATAPAL¹® B in an amount of 6 wt. % in water was mixed with an aqueous solutions containing 27.83 wt. % LAS as the sulfonic acid modifier. The mixture was mixed, at ambient temperature for 30 minutes after which the mixture was then dried in a spray dryer and the powder recovered. In a second case, CATAPAL® A alumina (a product essentially comparable to CATAPAL® B alumina in this application) is peptized with formic acid and spray dried to yield DISPAL® 30F4-80 powder. 31.3 g of the DISPAL® 30F4-80 alumina were dispersed in 390 g of diionized water and mixed at ambient temperature of 30 minutes. To this aqueous dispersion of DISPAL® alumina is added 125 g of an aqueous suspension containing 20 wt. % of LAS as a sulfonic acid modifier. This mixture was again mixed for an additional 30 minutes at ambient temperature. The resulting mixture was then spray dried to recover a solid product. The dried powders were made up at 5% wt. W/W levels in toluene. The percent dispersibility is shown in Table 5. ¹CATAPAL® and DISPAL® are registered trademarks of Sasol North America, Inc.

TABLE 5

| | Peptization | | | |
|---|---|---|---|---|
| | Prior to Sur- | | Mixing | |
| | face Modifi- | | Time | % Dispers- |
| | cation with | Modifier/ | (ambient | ibility |
| Alumina | Sulfonic Acid | Wt. % | temp.) | in Toluene |
| CATAPAL ®B | No | LAS/ | 30 min. | 0 |
| | | 27.83 | | |
| DISPAL ® | Yes | LAS/ | 30 min. | ~81 |
| X-30F4-80 | | 32.37 | | |

As can be seen in Table 5, in the absence of peptization, i.e., the formation of a stable, aqueous sol of the water dispersible metal oxide (boehmite alumina), the resulting product shows no dispersibility in a non-polar organic solvent such as toluene.

### EXAMPLE 6

The procedure of Example 1 was followed. The results are shown in Table 6 below where dispersibility is represented as a percent value rather than particle size as in Table 1.

TABLE 6

| | | Modifier | Dryer Outlet | |
|---|---|---|---|---|
| | | Loading | Temper- | % Dispers- |
| | | (mole %)/ | ature, | ibility |
| Alumina | Modifier | wt. % | ° C. | in Toluene |
| DISPAL ® 30F4-80 | LAS | 60/32.37 | 100 | ~81 |
| DISPAL ® 30F4-80 | LAS | 100/44.31 | 105 | ~99 |
| DISPAL ® 30F4-80 | LAS | 100/44.31 | 95 | ~65 |
| DISPAL ® 30F4-80 | LAS | 100/44.31 | 85 | ~64 |
| DISPAL ® 30F4-80 | LAS | 100/44.31 | 85* | ~99 |

*Post spray drying; same sample as above dried further in vacuum oven @ 60° C. for 12 hrs to improve dispersibility.

As can be seen from the data in Table 6, by increasing the loading of the sulfonic acid modifier, markedly enhanced dispersibility is achieved. As can also be seen from the data in Table 6, the drying temperature of the modified alumina has a marked effect on dispersibility. In particular, it should be noted that short residence time drying, such as spray drying, shows marked improvement at higher temperatures (e.g., 105° C.). However, materials spray dried at lower outlet temperatures (e.g., 85° C.) can be further dried at moderate temperatures in a long residence time drying process (e.g., vacuum oven) to achieve the same high dispersibility in toluene.

### EXAMPLE 7

This example demonstrates the effect of combining higher loading of the sulfonic acid modifier and higher drier outlet temperatures in producing a modified metal oxide (boehmite) having markedly enhanced dispersibility in non-polar organics. In essence, the procedure of Example 1 was followed. The relative loadings of the organic acid modifier and drier outlet temperatures are shown in Table 7 below. As can be seen from the data in Table 7, by increasing the loading of the sulfonic acid modifier and optimizing the spray drier outlet temperature at 105° C., dispersibility in non-polar organic solvents such as hexane and styrene increases dramatically.

TABLE 7

| | | Modifier | Dryer | % | % |
|---|---|---|---|---|---|
| | | Loading | Outlet | Dispers- | Dispers- |
| | | (mole %)/ | Temp., | ibility | ibility |
| Alumina | Modifier | wt. % | ° C. | Hexane | Styrene |
| DISPAL ® 30F4-80 | LAS | 60/32.37 | 100 | 56 | 0 |
| DISPAL ® 30F4-80 | LAS | 100/44.31 | 105 | 88 | 98 |

The following series of examples show how the peptization of the metal oxide (alumina) with a suitable acid prior to any admixing with the sulfonic acid modifier, particularly small (non-bulky) organic acid modifiers such as described above, produce aluminas that show marked dispersibility improvements in aprotic polar organic solvents such as ketones, aldehydes, etc.

### EXAMPLE 8

413 g of CATAPAL® B alumina was dispersed into 5,977 g of deionized water. In a separate container, 89 g of pTSA was dissolved into 500 g of deionized water. After thorough mixing, the pTSA solution as added to the alumina dispersion and allowed to mix 30 minutes. The resulting solution was spray dried to recover a surface treated alumina powder denoted as VLS#96a.

### EXAMPLE 9

93,144 g of CATAPAL® A slurry (12.7 wt. % solids) was dispersed into 100 kg of deionized water. In a separate container, 2,640 g of pTSA was dissolved in 4 kg of deionized water. After thorough mixing, the pTSA solution was added to the alumina dispersion and allowed to mix 15 minutes. The resulting solution was charged to a reactor where it was heated at 160° C. for 30 minutes. After cooling, the solution was spray died to recover the surface treated alumina powder denoted as V1228-45.

### EXAMPLE 10

This example demonstrates a two-step method for peptization and surface treatment. 836 g of CATAPAL® slurry (12.7 wt. % solids) was dispersed into 784 g of deionized water. In a separate container, 6.5 g of formic acid (88%) was diluted into 150 g of deionized water. After thorough mixing, the formic acid solution was added to the alumina dispersion and allowed to mix for 15 minutes. The resulting solution was charged to a reactor where it was heated at 160° C. for 30 minutes. After cooling, the solution was spray dried to recover the peptized alumina powder denoted as DISPAL® 30F4.

### EXAMPLE 11

413 g of DISPAL® 30F4, product of Example 10, was dispersed into 6,277 g of deionized water. In a separate container, 92.3 g of pTSA was dissolved into 200 g of deionized water. After thorough nixing, the pTSA solution was added to the alumina dispersion and allowed to mix 30 ninutes. The resulting solution was spray dried to recover the peptized and surface treated alumina powder denoted as VLS#91a.

### EXAMPLE 12

836 g of CATAPAL® slurry (12.7 wt. % solids) was dispersed into 784 g of deionized water. In a separate container 6.5 g of formic acid (88%) was diluted in the 150 g of deionized water. After thoroughly nixing, the formic acid solution was added to the alumina dispersion and allowed to mix for 15 minutes. The resulting solution was charged to a reactor where it was heated at 160° C. for 30 minutes. After cooling, the solution was spray dried to recover the peptized alumina powder denoted as DISPAL® 30F4.

### EXAMPLE 13

106 g of DISPAL® 30F4, product of Example 12, was dispersed into 1364 g of deionized water. In a separate container, 23 g of pTSA is dissolved into 300 g of deionized water. After thorough mixing, the pTSA solution was added to the alumina dispersion and allowed to mix 15 minutes. The resulting solution was charged to a reactor where it was heated at 160° C. for 30 minutes. After cooling, the solution was spray dried to recover the peptized and surface treated alumina powder denoted as VLS#90.

### EXAMPLE 14

This example demonstrates peptization and surface treatment in the one-step method. 106 g of CATAPAL® B powder was added to 1460 g of deionized water. In a separate container, 6.3 g of formic acid (88%) was diluted into 100 g of deionized water. After thorough mixing, the formic acid solution was added to the alumina dispersion and allowed to mix for 15 minutes. The resulting solution was charged to a reactor where it was heated at 160° C. for 30 minutes. The reactor was cooled to 65° C. and the alumina/formic acid solution removed (solution temperature upon removal 60° C. A pTSA solution (23 g of pTSA and 100 g of deionized water) was added to the alumina/formic acid solution and allowed to mix for 15 minutes. The alumina/formic acid/pTSA solution was spray dried to recover the peptized and surface treated alumina powder denoted as VLS#134.

The results of the experiments of Examples 8 and 9 are shown in Table 8 below. The results of the experiments of Examples 11 and 13 are shown in Table 9 below, and the results of the experiment of Example 14 are shown in Table 10 below.

TABLE 8
Surface Treatment Only - No Peptization

| | | | Surface | Surface | |
|---|---|---|---|---|---|
| | Peptizing | Peptizing | Treatment | Treatment | |
| Alumina | Agent | Conditions | Agent | Conditions | Dispersibility |
| CATAPAL ® B | None | | pTSA | Mix 30 min | Water 4% |
| VLS #96a | | | | 23 C. | MeOH 97% |
| | | | | | Acetone 43% |
| | | | | | MEK 30% |
| CATAPAL ® A | None | | pTSA | 160 C./30 min. | Water 0% |
| V1228-45 | | | | | MeOH 99% |
| | | | | | Acetone 24% |
| | | | | | MEK 30% |

TABLE 9
Peptization and Surface Treatment - 2-Step Method

| | | | Surface | Surface | |
|---|---|---|---|---|---|
| | Peptizing | Peptizing | Treatment | Treatment | |
| Alumina | Agent | Conditions | Agent | Conditions | Dispersibility |
| CATAPAL ® A | Formic Acid | 160 C./30 min | pTSA | Mix 30 min | Water 0% |
| VLS #91a | | Cool | | 23 C. | MeOH 98% |
| | | Spray | | Spray dry | Acetone 91% |
| | | Redisperse | | | MEK 97% |
| | | powder in water | | | |
| CATAPAL ® A | Formic Acid | 160 C./30 min | pTSA | 160 C./30 | Water 0% |
| VLS #90 | | Cool | | min | MeOH 98% |
| | | Spray dry | | Cool | Acetone 97% |
| | | Redisperse | | Spray dry | MEK 98% |
| | | powder in water | | | |

TABLE 10
Peptization and Surface Treatment - 1-Step Method

| | | | Surface | Surface | |
|---|---|---|---|---|---|
| | Peptizing | Peptizing | Treatment | Treatment | |
| Alumina | Agent | Conditions | Agent | Conditions | Dispersibility |
| CATAPAL ® B | Formic Acid | 160 C./30 min | pTSA | Mix 30 min at | Water 0% |
| VLS #134 | | Cool to 60 C. | | 60 C. | MeOH 97% |
| | | | | | Acetone 96% |
| | | | | | MEK 96% |

As can be seen from the data in Table 8 above, treatment of the alumina with pTSA alone and no peptization results in poor dispersibility in polar organic solvents such as acetone and methy ethyl ketone (MEK).

As shown in Tables 9 and 10, peptization with formic acid of the alumina followed by surface modification with pTSA results in a marked increase in the dispersibility of the modified alumina in acetone and MEK.

Overall as can be seen from the above, by tailoring the treatment of the water dispersible metal oxide, the amount of the sulfonic acid modifier employed, the drying temperature (outlet temperature from spray dryer) and other parameters, metal oxides such as boehmite alumina can be produced which are dispersible, at high levels (greater than 85%) in a wide variety of organic solvents, both polar and non-polar. The method of the present invention produces modified metal oxides which can be dispersed in organic matrices, e.g., apolar organic liquids, to form stable sols in the sense that the modified metal oxides remain dispersed, under quiescent conditions. Additionally, depending on the particular metal oxide and its concentration in the apolar organic liquid, the sol of the modified metal oxide and the apolar organic liquid range from being transparent to translucent, i.e., they generally have NTU values of less than 1,000.

The invention is characterized by the addition of a well peptized aqueous sol of a metal oxide, e.g., alumina, to a solution (dispersion) of an anionic surfactant such as sulfonic acid modifier at ambient temperature with good mixing. Using this mixing order insures an excess of sulfonic and modifier with respect to the available alumina surface area. When bulky sulfonic acid modifiers are formed, it is believed that the (sulfonic acid modifier coats and saturates the alumina surface, causing an alumina/modifiers floc to form that settles from the aqueous phase due to thermodynamic incompatibility. Upon reagitation, the floc can be filtered or centrifuged to produce a wet cake that can be oven dried. Alternatively, and more commonly, the suspended floc can be spray dried to produce a fine, dried powder. In either case, the resulting powder can be redispersed in non-polar solvents to produce stable, transparent organo-sols of the metal oxide with dispersed particle sizes similar to those of the starting aqueous metal oxide sols.

Representative but non-limiting applications for the compositions obtained by this process includes catalysts and catalyst supports; coatings; adsorbents; surface treatments; ceramics and refractories; reinforcement of ceramics, metals, plastics and elastomers; scratch resistant coatings; agents for the delivery of pharmaceutically active materials; thickening agents and rheology modifiers; rinse aids; fabric treatment; paper treatment; inkjet recording media; soil resistant coatings; and barrier coatings

The foregoing description and examples illustrate selected embodiments of the present invention. In light thereof, variations and modifications will be suggested to one skilled in the art, all of which are in the spirit and purview of this invention.

1. A method of preparing a metal oxide which is dispersible in organic matrices comprising:
forming a reaction product mixture by adding an aqueous, peptized sol of a metal oxide to an aqueous suspension of a sulfonic acid modifier having the structure
X(SO_{y}M)ₙ
wherein X is an organic moiety, M is a monovalent cation, y is 3 or 4, and n is an integer reflecting the number of —SO_{y}M groups bonded to the organic moiety, to form a modified metal oxide; and
recovering said modified metal oxide from said reaction product mixture.

2. The method of claim 1 wherein said metal oxide is selected from the group consisting of aluminas, aluminum silicate, silicon—aluminum oxides, silicas and mixtures thereof.

3. The method of claim 2 wherein said metal oxide comprises an alumina.

4. The method of claim 1 wherein said mixture is heated to a temperature of from 30 to 170° C.

5. The method of claim 1 wherein the weight ratio of metal oxide, calculated as metal oxide, to sulfonic acid modifier, calculated as X(SO_{y})ₙM, is from 98:2 to 70:30.

6. The method of claim 1 wherein said recovered modified metal oxide is dried at a temperature of from 80 to 120° C.

7. A method of forming a composition comprised of a metal oxide dispersed in an organic matrix comprising:
forming a reaction product mixture by adding an aqueous, peptized sol of a metal oxide and to an aqueous suspension of a sulfonic acid modifier having the structure
X(SO_{y}M)ₙ
wherein X is an organic moiety, M is a monovalent cation, y is 3 or 4, and n is an integer reflecting the number of —SO_{y}M groups bonded to the organic moiety to form a modified metal oxide.
recovering said modified metal oxide from said reaction product mixture; and
dispersing said modified metal oxide in said organic matrix.

8. The method of claim 7 wherein said organic matrix is an apolar organic liquid.

9. The method of claim 8 wherein said organic liquid comprises a liquid aromatic compound.

10. The method of claim 7 wherein said modified metal oxide is present in said organic matrix in an amount of from 1 to 40 wt. % based on the combined weight of organic matrix and modified metal oxide.

11. The method of claim 7 wherein said metal oxide is selected from the group consisting of aluminas, aluminum silicate, silicon—aluminum oxides, silicas and mixtures thereof.

12. The method of claim 11 wherein said metal oxide comprises an alumina.

13. The method of claim 7 wherein the weight ratio of metal oxide, calculated as metal oxide to sulfonic acid modifier, calculated as X(SO_{y})ₙM, is from 98:2 to 70:30.

14. The method of claim 7 wherein said recovered modified metal oxide is dried at a temperature of from 80 to 120° C.

15. The method of any of claims 1 or 7 wherein said sulfonic acid modifier has the structure 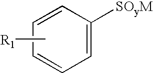
wherein R₁ is an organic moiety having from 7 to 20 carbon atoms, y is 3 or 4 and M is a monovalent cation.

16. The method of claim 15 wherein R₁ is an alkyl group.

17. The method of claim 15 wherein R₁ is an alkyl group containing from 10 to 14 carbon atoms.

18. A method of preparing a metal oxide which is dispersible in organic matrices comprising:
forming a reaction product mixture by adding an aqueous, peptized sol of a metal oxide to an aqueous suspension of a sulfonic acid modifier having the formula:
X(SO_{y}M)ₙ
wherein X is an organic moiety, M is a monovalent cation, y is 3 or 4, and n is an integer reflecting the number of —SO_{y}M groups bonded to the organic moiety, to form a modified metal oxide, the weight ratio of metal oxide, calculated as metal oxide, to sulfonic acid modifier, calculated as X(SO_{y})ₙM being from 98:2 to 50:50;
recovering said modified metal oxide from said reaction product mixture; and
drying said modified metal oxide at a temperature of from 105 to 115° C.

19. The method of claim 18, wherein said sulfonic acid modifier is LAS.

20. The method of claim 18, wherein said drying is conducted by spray drying.

21. The method of claim 18, wherein said drying is conducted in an oven.

22. The method of any of claims 1, 7 or 18, wherein said aqueous sol of said metal oxide is prepared by peptizing said metal oxide with an aqueous solution of a mono-protic acid having a pKa value of less than 6.

23. A method of preparing a metal oxide which is dispersible in aprotic polar organic liquids comprising:
reacting an aqueous solution of a water dispersible metal oxide with an aqueous solution of a mono-protic acid having a pKa value of less than 6 to produce a peptized, aqueous sol of said metal oxide;
mixing said aqueous sol of said metal oxide with an aqueous suspension of a sulfonic acid modifier selected from the group consisting of compounds having the formula:
RSO_{y}M
wherein R is an organic group having from 1 to 12 carbon atoms, M is a monovalent cation, and y is 3 or 4, compounds having the formula: 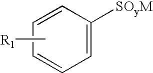
wherein R₁ is an organic moiety containing from 1 to 6 carbon atoms, and wherein R₁ can be substituted with functional groups, and mixtures thereof, to form a reaction product mixture; and
recovering modified metal oxide from said reaction product mixture.

24. The method of claim 23, wherein said mono-protic acid is a carboxylic acid having from 1 to 4 carbon atoms.

25. The method of claim 24 wherein said mono-protic acid is formic acid.

26. The method of claim 23, wherein said mono-protic acid is nitric acid.

27. The method of any of claims 19 or 23, wherein said metal oxide is boehmite alumina.
